(19) United States
(12) Patent Application Publication
(10) Pub. No.: US 2017/0164263 A1
(43) Pub. Date: Jun. 8, 2017

(54) Routing And Transmission In Mesh Networks

(71) Applicant: Telefonaktiebolaget LM Ericsson (publ), Stockholm (SE)

(72) Inventors: Bengt LINDOFF, Bjärred (SE); Magnus ÅSTROM, Lund (SE); Fredrik NORDSTROM, Lund (SE)

(73) Assignee: Telefonaktiebolaget LM Ericsson (publ)

(21) Appl. No.: 15/316,231

(22) PCT Filed: Jun. 13, 2014
(86) PCT No.: PCT/EP2014/062384

§ 371 Date: Dec. 5, 2016

(51) Int. Cl. H04W 40/12; H04W 72/04; H04W 40/04; H04L 12/707; H04L 12/727

(52) U.S. Cl. CPC H04W 40/12; H04L 45/24; H04L 45/121; H04W 40/04; H04W 72/046; H04W 72/0446; H04W 72/0453; H04W 84/18

(57) ABSTRACT

The proposed technology relates to wireless meshed networks and in particular it relates to sending a data packet from a first node to a second node, wherein the data packet is divided into sub packets and sent via at least two different transmission paths to the second node from the first node. According to one aspect the disclosure relates to a method, performed in a first node in a wireless network comprising a number of nodes wirelessly connected to each other. The method comprises sending a data packet from the first node to a second node. There are at least two possible transmission paths between the first node and the second node and at least one of the at least two possible transmission paths comprises an intermediate node. The method comprises the steps of creating at least two sub packets, each sub packet comprising at least a part of the data packet, and sending the sub packets to a respective receiving node, each receiving node being part of a respective transmission path between the first node and the second node. The proposed technology also relates to a first node and an intermediate node for implementing the method and to a corresponding computer program.

### TECHNICAL FIELD

The proposed technology relates to wireless meshed networks and in particular it relates to sending a data packet from a first node to a second node, wherein the data packet is divided into sub packets and sent via at least two different transmission paths to the second node from the first node. The proposed technology also relates to a first node and an intermediate node for implementing the method and to a corresponding computer program.

### BACKGROUND

3GPP Long Term Evolution, LTE, is the fourth-generation mobile communication technology standard developed within the 3rd Generation Partnership Project, 3GPP, to improve the Universal Mobile Telecommunication System, UMTS, standard to cope with future requirements in terms of improved services such as higher data rates, improved efficiency, and lowered costs. In a typical cellular radio system, wireless devices or terminals also known as mobile stations and/or User Equipment units, UEs, communicate via a Radio Access Network, RAN, to one or more core networks. The Universal Terrestrial Radio Access Network, UTRAN, is the radio access network of a UMTS and Evolved UTRAN, E-UTRAN, is the radio access network of an LTE system. In an UTRAN and an E-UTRAN, a UE is wirelessly connected to a Radio Base Station, RBS, commonly referred to as a NodeB, NB, in UMTS, and as an evolved NodeB, eNB or eNodeB, in LTE. An RBS is a general term for a radio network node capable of transmitting radio signals to a UE and receiving signals transmitted by a UE.

Future communication systems are expected to, in many situations, be based on ad-hoc networks instead of, or in combination with, today's cellular communication approach with a central node, to which every device within reach of the central node should transmit the data. The development within wireless networking is going towards solutions where different radio access technologies, RAT, are supposed to be more numerous and more integrated. As an example, capillary networks are already today used to connect sensors, meaning that within an area there are several sensors or devices connected with each other, typically using a Radio Access Technology utilizing an unlicensed spectrum like Bluetooth or WLAN. One or several of the sensors or devices may also be connected to one or a few nodes that act as gateways to other networks or to the internet. In an example implementation, the communication to other networks or to the internet is made over another Radio Access Technology used in licensed band e.g. LTE, then the gateway or relay nodes are devices having cellular communication capabilities.

In addition, the amount of data transmitted over wireless networks is constantly increasing. Machine to machine, M2M, communication over mobile and wireless networks is expected to become increasingly important in the future.

In prior art meshed networks such as according to the standard IEEE 802.11s, the path setup is performed by an Ad hoc On-Demand Distance Vector, AODV, using the airtime link metric, which is an estimation of the total transmission “air time” for a packet. The modulation and coding scheme for the given metric is based on “a priori” information about the channel and is commonly based on reception of previous acknowledgement/non-acknowledgement, ACK/NACK, messages or from sounding requests that are independent from mesh signaling. Hence, from a system capacity point of view this is a very cumbersome and inaccurate procedure, in particular in a mesh network. Furthermore, related to the inherent stationary WLAN networks, during transmission a transmitting node will only have very rough information regarding link quality by receiving ACK/NACK:s from the receiving node.

Building statistics regarding link quality may take some time and during the build-up phase there will be significant risk for unnecessary packet delays on the Internet Protocol, IP, level that may reduce the Quality of Service, QoS, in delay sensitive applications. Additionally, in a dynamic network the statistics is quickly outdated, again implying suboptimal performance.

It is well known in the art of mesh networks to choose routing based on channel quality for respective possible route to use, see for example United States Patent Application Publications US2009168653 A1 and US2006034233 A1.

Furthermore, in some prior art documents adaptation of Modulation and Coding Scheme, MCS, used for the chosen route is disclosed. One example is United States Patent Application Publication US2010329134 describing a method for reporting Channel Quality Indicator, CQI, and based on that reporting together with information of current data packet delay and number of remaining nodes to pass for the packet to the end destination a Modulation and Coding Scheme is chosen. Hybrid Automatic Repeat reQuest, HARQ may also be disabled or enabled or the Block Error Rate, BLER, target may be adapted based on said reporting and said information.

Hybrid Automatic Repeat ReQuest is a repetition technique that enables faster recovery from errors in cellular networks by storing corrupted packets in the receiving device rather than discarding them. When using HARQ, a retransmission may be requested if a packet is received with low quality, which may cause delays.

In this situation, it must be considered that in some applications, for instance due to the respective link quality for possible routes of a data packet, it might not be possible to fit the packet in one single transmission, and fragmentation of the packet in time implies time delay of the packet.

Hence, prior art solutions will not solve all possible delay scenarios and therefore there is a need for reducing the delay as well as increasing throughput and system capacity in meshed networks.

### SUMMARY

An object of the present disclosure is to provide methods and nodes which seeks to mitigate, alleviate, or eliminate one or more of the above-identified deficiencies in the art and disadvantages singly or in any combination and to provide a solution wherein the throughput and system capacity in a meshed network is increased. The present disclosure proposes methods and nodes for transmitting a data packet between two nodes in wireless networks.

More specifically, the disclosure proposes methods and nodes for transmitting a data packet over multiple paths in a meshed network. In the proposed methods the paths, Modulation and Coding Scheme, MCS, and BLock Error Rate, BLER, target are chosen based on total accumulated delay (or number of links in the meshed network) in combination with CQI information. This results in an increase of total spectral capacity as well as improved end-to-end throughput, latency, packet reception rate and overall QoS.

The present disclosure is defined by the appended independent claims. Various advantageous embodiments of the disclosure are set forth by the appended dependent claims as well as by the following description and the accompanying drawings.

According to some aspects of the disclosure, it provides for a method, performed in a first node in a wireless network comprising a number of nodes wirelessly connected to each other. The method comprises sending a data packet from the first node to a second node. There are at least two possible transmission paths between the first node and the second node and at least one of the at least two possible transmission paths comprises an intermediate node. The method comprises the steps of creating at least two sub packets, each sub packet comprising at least a part of the data packet, and sending the sub packets to a respective receiving node, each receiving node being part of a respective transmission path between the first node and the second node.

In other words, sub packets are made of the data packet and transmitted via different transmission paths in the physical layer, also known as the first layer, in a meshed network. Hence, one sub packet may be routed via one intermediate node and another sub packet may be routed via another intermediate node. At the destination, i.e. the second node, the sub packets are merged. An advantage with this is that data packets may be sent efficiently by dividing the amount of data to be sent between different transmission paths thus saving time and optimizing use of the network capacity.

According to some aspects of the disclosure, the method further comprises the step of obtaining at least one channel quality parameter, wherein each channel quality parameter is associated with one of the at least two possible transmission paths from the first node to the second node and according to some aspects of the disclosure, the method further comprises the step of selecting at least two transmission paths of the at least two possible transmission paths for sending a data packet from the first node to the second node based on channel quality parameters.

Thus, an indication of the quality of the transmission paths is obtained, wherein the transmissions could further be based on the properties of the different possible paths in order to optimize the chance of successful transmission. By basing the selection on the channel quality parameters it is possible to optimize the transmission paths for the sub packets so that they are sent over transmission paths which will give the best possible throughput.

According to some aspects of the disclosure, the sending implies that the second node can decode the data packet using the at least two sub packets, when arriving at the second node. In other words, the second node, which is the target node for the whole data packet, receives all sub packets and from them decodes the original data packet.

According to some aspects of the disclosure, the method further comprises the step of determining transmission properties of the respective selected transmission path. By setting the transmission properties for each transmission path the transmission of each sub packet is optimized for each specific path and packet.

According to some aspects of the disclosure, the step of sending further comprises sending the at least two sub packets to a respective node using different physical resources in time and/or frequency domain and/or in the spatial domain. Thus, the transmission from the first node may still be done at least partly simultaneously in one transmission, whereby the sub packets are separated in time/frequency and/or space.

According to some aspects of the disclosure, the step of selecting further comprises selecting the sub packet to be sent on each respective selected transmission path.

According to some aspects of the disclosure, the sub packets are, at least partly, different parts of the data packet or the sub packets are copies of the data packet. Accordingly, the sub packets may be copies of the data packet for redundancy in the transmission or comprise different parts of the data packet.

According to some aspects of the disclosure, the method further comprises the step of determining the number of links in a possible transmission path from the first node to the second node, wherein a link is a direct connection between two nodes, and wherein the selection is further based on the number of links. Since the number of links has an impact on the delay of a packet and on the bit error rate, the selection is further based on the number of links.

According to some aspects of the disclosure, the step of determining further comprises determining a number of previous links that the data packet has passed on its way to the first node and/or accumulated delay from previous transmissions of the data packet and wherein the selection is further based on the number of previous links and/or the delay. In some cases the accumulated delay and expected bit error rate from previous transmissions is so high that it is preferred that future transmissions introduces minimum delay and bit errors in the data packet and the selection is therefore performed to handle this.

According to some aspects of the disclosure the selection is further based on transmission requirements associated with the data packet. When the transmission requirement is for example that the packet is to be received quickly, the data packet is for example split in several smaller sub packets and sent over several transmission paths so that all the sub packets arrive at the second node as fast as possible.

According to some aspects of the disclosure, the method further comprises the step of instructing possible receiving nodes to report quality measurements to the first node. In other words, the first node needs information about quality measurements in possible receiving nodes so that the selection of transmission paths may be based on the information.

According to some aspects of the disclosure, the step of instructing further comprises instructing possible receiving nodes to report other data to the first node. Such other data is for example quality measurements from future possible receiving nodes located between the possible receiving node and the second node. The information is used when selecting the transmission path for each sub packet.

According to some aspects of the disclosure, each sub packet comprises information associated with the other sub packets. The information is for example associated with the transmission path from the first node to the second node of each other sub packet. The information comprises for example the identity of the second node and/or information which defines the content of each sub packet.

According to some aspects of the disclosure the information in each sub packet comprises instructions for the receiving node, being an intermediate node, whether to feed forward the sub packet without decoding or to decode and re-encode it and/or synchronization information associated with future transmissions of the at least two sub packets.

According to some aspects of the disclosure the information in each sub packet defines Modulation and Coding Scheme, MCS or Resource Blocks, RB used for transmission of the other sub packets and/or accumulated latency and/or diversity index. According to some aspects of the disclosure the information in each sub packet is comprised in headers of the at least two sub packets.

The information in the sub packets enables the second node to decode the original data packet from the sub packets. It also enables for the nodes which sends the sub packets to the second node to synchronize their transmissions.

According to some aspects of the disclosure, it provides for a first node in a wireless network comprising a number of nodes wirelessly connected to each other. The first node being configured for sending a data packet from the first node to a second node and wherein there are at least two possible transmission paths between the first node and the second node and at least one of the at least two possible transmission paths comprises an intermediate node. The first node is configured to create at least two sub packets, each sub packet comprising at least a part of the data packet, and to send the sub packets to a respective receiving node. The respective receiving node is part of a respective transmission path between the first node and the second node.

According to some aspects of the disclosure the wireless network is a Mobile Adhoc Network, MANET, a mesh network, a Personal Area Network, PAN, or a Device to Device network, D2D.

According to some aspects of the disclosure the first node is a wireless device, an access point or a base station.

According to some aspects of the disclosure, it provides for a method, performed in an intermediate node in a wireless network comprising a number of nodes wirelessly connected to each other, of forwarding a sub packet from a first node towards a second node. In the proposed method, at least a first and a second sub packet are transmitted over different transmission paths between the first node and the second node, each sub packet comprising at least a part of a data packet. The intermediate node is located in one of the transmission paths. The method comprises the steps of receiving the first sub packet sent from the first node, wherein the first sub packet comprises information associated with the other sub packets, and sending the sub packet to the second node, or to another intermediate node, based on the received information.

According to some aspects of the disclosure the method further comprises processing the sub packet based on the received information and transmission properties of the intermediate node.

According to some aspects of the disclosure the processing comprises decoding the sub packet if the quality is below a value. According to some aspects of the disclosure the information comprises a latency flag and/or best suitable Resource Blocks, RB.

According to some aspects of the disclosure the information comprises synchronization requirements associated with future transmissions of the first sub packet, and wherein the sending is based on the synchronization information.

According to some aspects of the disclosure, it provides for an intermediate node in a wireless network comprising a number of nodes wirelessly connected to each other. The intermediate node is configured for forwarding a sub packet from a first node towards a second node. In the proposed methods at least a first and a second sub packet are transmitted over different transmission paths between the first node and the second node, each sub packet comprising at least a part of a data packet and the intermediate node is located in one of the transmission paths. The intermediate node is configured to receive the first sub packet transmitted from the first node, wherein the first sub packet comprises information associated with the other sub packets, and to send the sub packet to the second node, or to another intermediate node, based on the received information.

According to some aspects of the disclosure, it provides for a computer program, comprising computer readable code which, when run on a node in a contention based communication system, causes the node to perform the method according to above.

With the above description in mind, the object of the present disclosure is to overcome at least some of the disadvantages of known technology as previously described.

### BRIEF DESCRIPTION OF THE DRAWINGS

The present technique will be more readily understood through the study of the following detailed description of the embodiments/aspects together with the accompanying drawings, of which:

FIG. 1 illustrates a wireless mesh network.

FIG. 2 is a schematic diagram illustrating a first node configured for sending a data packet from the first node to a second node.

FIG. 3 is a flow chart illustrating the proposed method, performed in the first node, for sending a data packet from the first node to the second node according to an exemplary embodiment of the present disclosure.

FIG. 4a illustrates the time consumption of sending a packet split into sub packets over different transmission paths compared to sending them over the same.

FIG. 4b illustrates the time consumption of sending a copied packet over different transmission paths compared to sending a split packet over the same.

FIG. 5a illustrates sending a sub packet using different physical resources the time and frequency domain.

FIG. 5b illustrates sending a sub packet using different physical resources in the spatial domain.

FIG. 6 is a schematic diagram illustrating an intermediate node configured for forwarding a sub packet from a first node towards a second node.

FIG. 7 is a flow chart illustrating the proposed method, performed in an intermediate node, of sending a data packet from the first node to the second node according to an exemplary embodiment of the present disclosure.

### DETAILED DESCRIPTION

Aspects of the present disclosure will be described more fully hereinafter with reference to the accompanying drawings. The nodes and methods disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

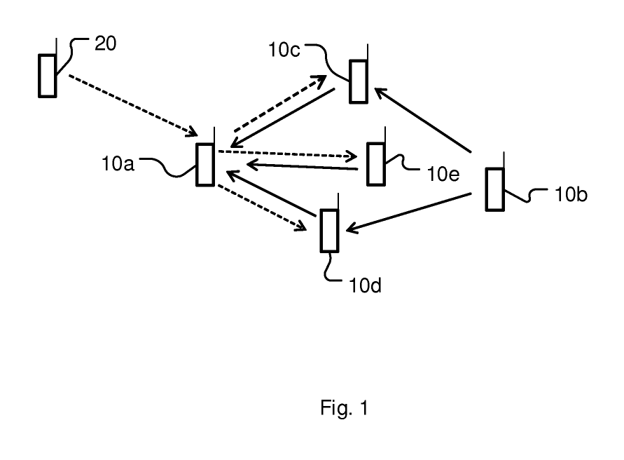

In general, routing can be defined as the act of moving information from a source node to a destination node via one or more intermediate nodes in a communication network. In a multi-hop network, nodes out of reach from each other may benefit from intermediately located nodes that can forward their messages from the source towards the destination. In this disclosure the source node is addressed as the first node 10a and the destination node is addressed as the second node 10b, see FIG. 1.

Routing generally involves two basic tasks: determining suitable routing paths and transporting information through the network. In the context of the routing process, the first of these tasks is normally referred to as route determination and the latter of these tasks is often referred to as packet forwarding.

A path or route connects two nodes in a network. In a multi-hop network a path comprises a sequence of links and nodes. The path is defined by the properties of the links such as bit-rate or latency. The path may as well be affected by the properties of the nodes.

The proposed technology is generally applicable to any wireless routing protocol, independent of implementation, including both distributed and centralized routing algorithms, hop-by-hop routing as well as source-routing, link-state routing and distance-vector routing, proactive or reactive routing, flat or hierarchical routing and multi-path routing, as well as variations and combinations thereof. As part of the development of the example embodiments presented herein, a problem will first be identified and discussed.

As previously discussed, routing is used in order to transmit a packet of data from a source to a destination node via intermediate nodes acting as relays between source and destination. In wired systems where typically the bit error rates are negligible and any collisions are immediately detected upon transmission, resulting in a fixed per-link routing cost, routing is performed on the IP level, using IP addresses.

Wireless routing, on the other hand, differs from wired in that wireless channels are significantly less reliable and more variable. The cost of routing a packet through a certain link is no longer constant but instead depending on the channel between the nodes. In order to optimize performance with respect to either sparse radio spectrum resources, and/or packet latency, routing is performed on a lower layer where knowledge of the wireless channel properties exists. In its simplest form, knowledge of a successful transmission of a packet along the route is obtained by the receiver transmitting an Acknowledgement message back to the transmitter.

The present disclosure proposes a method for transmitting a data packet over multiple transmission paths. This is typically done in combination with optimizing of Modulation and Coding Scheme, MCS, for respective chosen path by adapting the BLock Error Rate, BLER, target in a meshed network with Hybrid Automatic Repeat Request, HARQ, functionality for the first transmission of a data packet per link based on e.g. total accumulated delay, or number of links, in combination with CQI information. Thereby, increase of total spectral capacity as well as increased end-to-end throughput, latency, packet reception rate and overall QoS is achieved.

FIG. 1 illustrates a meshed wireless network, wherein the proposed methods may be implemented. The meshed network comprises a number of wireless nodes 10a to 10e wirelessly connected to each other, being a subset of connected nodes in an ad hoc or mesh network. In this example the nodes are user equipment, UE, but the same principle could be applied to any wireless network comprising wirelessly connected nodes. In the network, packets may be delivered from a first node 10a (the packets may be originated from another node 20) to a second node 10b. Then, the first node 10a need to choose a route via intermediate nodes 10c, 10d or 10e. According to the proposed technique the first node 10a chooses a combination of two or three routes for simultaneous transmissions of sub packets to the second node 10b.

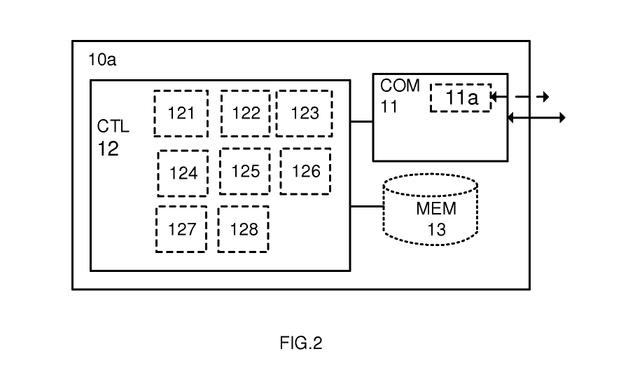

FIG. 2 illustrates an example node configuration of a first node 10a, which may incorporate some of the example embodiments discussed above. The communication system is a wireless meshed network, implying that a packet can be sent from the first node to the second node 10b via different transmission paths. According to some aspects, the first node is a wireless device or network node. In some embodiments the wireless node is the source of data packet (for instance originated on application level in the wireless node). In other embodiments, the wireless node is a network node where data packet may have been received via a wired backhaul. It may just as well be the other way around, that the second node is connected, or actually that both nodes are connected to an external wired or wireless network. The proposed methods may e.g. be implemented in a sensor network where the information flow is from one or several sensors to a server on the internet. In another embodiment the wireless node receive the data packet from another wireless node 20. The first node determines the target destination for the data packet, typically by reading an address in a packet header associated to the target destination/node. As shown in FIG. 2, according to aspects, the first node comprises a communication interface or radio circuitry 11 configured to receive and transmit any form of communications or control signals within a network. In other words, the first node comprises a communication interface 11 configured for wireless communication with other nodes 10b-e in the wireless network. It should be appreciated that the radio circuitry 11 according to some aspects comprises any number of transceiving, receiving, and/or transmitting units or circuitry. It should further be appreciated that the radio circuitry 11 may be in the form of any input/output communications port known in the art. The radio circuitry 11 according to some aspects comprises RF circuitry and baseband processing circuitry (not shown).

The first node 10a, according to some aspects, further comprises at least one memory unit or circuitry 13 that may be in communication with the radio circuitry 11. The memory 13 may be configured to store received or transmitted data and/or executable program instructions. The memory 13 may be any suitable type of computer readable memory and may be of volatile and/or non-volatile type.

The first node 10a, according to some aspects, further comprises processing circuitry 12, which is any suitable type of computation unit, e.g. a microprocessor, Digital Signal Processor, DSP, Field Programmable Gate Array, FPGA, or Application Specific Integrated Circuit, ASIC, or any other form of circuitry. It should be appreciated that the processing circuitry need not be provided as a single unit but may be provided as any number of units or circuitry. According to some aspects the processing circuitry 12 is configured to create at least two sub packets P′, each sub packet comprising at least a part of the data packet P, and to send, using the communication interface 11, the sub packets to a respective receiving node 10b-d. The respective receiving node is part of a respective transmission path between the first node 10a and the second node 10b. The determination steps may be based on stored information. The information may be stored in a data base in the wireless node and received in earlier reception of data information from other nodes.

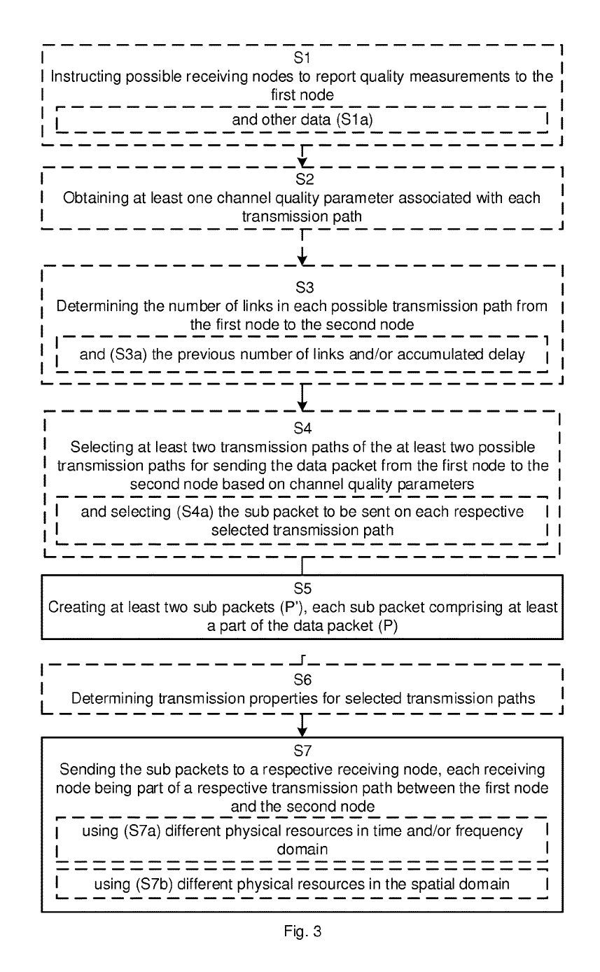

FIG. 3 is a flow diagram depicting example operations which may be performed by the first node of FIG. 2, when transmitting a packet from the first node 10a to a second node 10b. It should be appreciated that FIG. 3 comprise some operations which are illustrated with a solid border and some operations which are illustrated with a dashed border. The operations which are comprised in a solid border are operations which are comprised in the broadest example embodiment. The operations which are comprised in a dashed line are example embodiments which may be comprised in, or a part of, or are further operations which may be taken in addition to the operations of the broader example embodiments. It should be appreciated that these operations need not be performed in order. Furthermore, it should be appreciated that not all of the operations need to be performed. The example operations may be performed in any order and in any combination.

The proposed technique will now be briefly described referring to FIGS. 2 and 3. As previously discussed, the disclosure provides for a method, performed in a first node 10a in a wireless network comprising a number of nodes 10a-e wirelessly connected to each other. The method comprises sending a data packet P from the first node 10a to a second node 10b. There are at least two possible transmission paths between the first node and the second node and at least one of the at least two possible transmission paths comprises an intermediate node 10c, 10d. A data packet comprises a number of bits. A data packet is for example a transport block or a block.

The method comprises the steps of creating S5 at least two sub packets P′ that comprise at least a part of the data packet. The processing circuitry 12 is configured to create the at least two sub packets, each sub packet comprising at least a part of the data packet P. According to some aspects the processing circuitry comprises a creater 121 for creating the at least two sub packets. This step implies that the first node creates two different packets representing the data of the original packet that is to be sent to a second node. This is typically done in order to optimize the transmission, as will further be explained below.

The method further comprises sending S7 the sub packets to a respective receiving node 10b-d, each receiving node being part of a respective transmission path between the first node 10a and the second node 10b. The communication interface 11 is configured to send the sub packets to a respective receiving node 10b-d. The respective receiving node is part of a respective transmission path between the first node 10a and the second node 10b. According to some aspects the communication interface comprises a radio transmitter circuit 11a for sending the sub packets. The receiving nodes for the sub packets are either an intermediate node or the second node. According to some aspects the sending of the sub packets is performed at least partly simultaneously. The respective sub data packets may use different MCS and BLER targets.

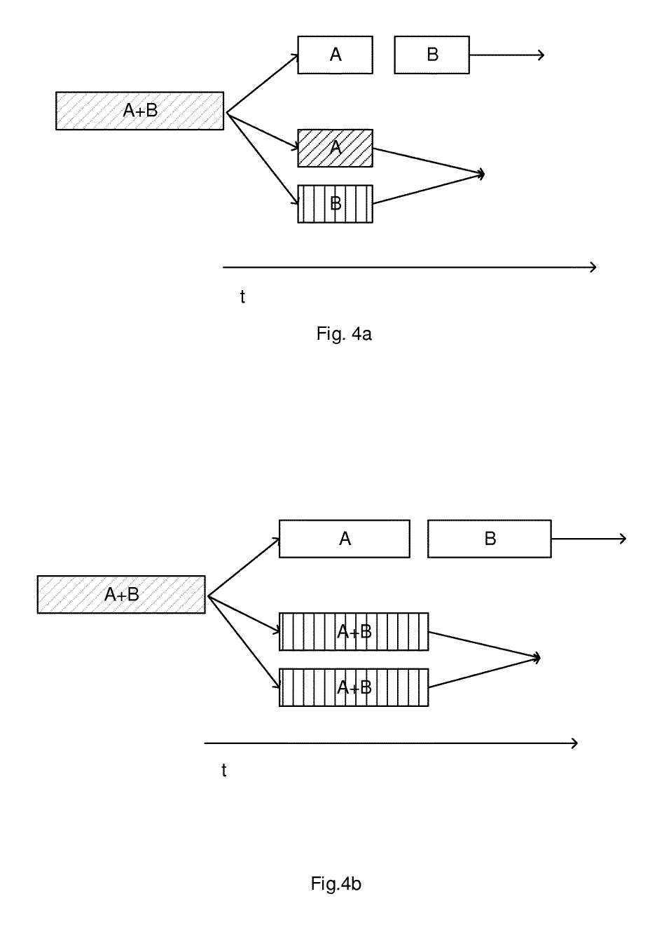

In other words, sub packets are made of the original data packet and transmitted via different transmission paths on the physical layer, also known as the first layer, in a network. Thus, a wireless first node 10a transmits a data packet and has possibility to route the packet at least via two intermediate nodes to a second target node. The second node may be a device, access point, tablet, modem, or a sensor. An advantage with this is that data packets may be sent efficiently by dividing the amount of data to be sent between different transmission paths, thus saving time and optimizing use of the network capacity. See FIGS. 4a and 4b for examples of where a data packet is sent using the proposed technique. The figures illustrate that a data packet A+B that is divided into sub packets A and B and if sent sequentially over one path (top illustration in FIGS. 4a and 4b) will, in the case of 4a, take longer time, or in the case of 4b, be less likely to be correctly received, than if the packet is divided into two sub packets as in 4a, or copied into two sub packets as in 4b, and sent over two different transmission paths (bottom illustration in FIGS. 4a and 4b).

FIG. 4 illustrates a scenario, when a packet A+B is to be transmitted. However, in order to achieve the required quality encoding is required, which implies that the encoded packet size would be above the supported packet size. According to prior art, the packet may then have to be retransmitted or fragmented into smaller packets that would be subsequently transmitted, which would cause delays. The below parts of FIGS. 4a and 4b illustrates how the proposed methods may solve this.

In FIG. 4a the data packet A+B is split into two fragments, or sub packets, A, B that are transmitted over different transmission paths. In FIG. 4b the original data packet A+B is transmitted two times over different paths, even though the channel quality is low. However, at the receiver side the data from the two transmissions may be combined in order to maintain quality.

According to some aspects the method further comprises obtaining S2 at least one channel quality parameter, wherein each channel quality parameter is associated with one of the at least two possible transmission paths from the first node 10a to the second node 10b. The processing circuitry 12 is configured to obtain, using the communication interface 11, the at least one channel quality parameter. According to some aspects the processing circuitry comprises an obtainer 122 for obtaining the channel quality parameter. Thus an indication of the quality of the transmission paths is obtained.

According to some aspects, the method further comprises the step of selecting S4 at least two transmission paths of the at least two possible transmission paths for sending a data packet P from the first node 10a to the second node 10b based on channel quality parameters. The processing circuitry 12 is configured to select the at least two transmission paths. According to some aspects the processing circuitry comprises a selector 123 for selecting the transmission paths. By basing the selection on the channel quality parameters it is possible to optimize the transmission paths for the sub packets so that they are sent over transmission paths which will give the best possible throughput.

The nodes in the meshed network generally configure channel measurement reports comprising such channel quality parameters for adjacent nodes, i.e. a first node informs nodes that are in connection to the first node to report CQI (for instance) reports on regular basis, for instance every 10 ms or so. The CQI reports may inform of the channel quality over the entire frequency bandwidth (wideband CQI) or CQI report related to several subset of the system bandwidth (sub-band CQI). The CQI information may contain information about preferred MCS, rank and precoding matrix for MIMO and beamforming information for Multi User Multiple-Input and Multiple-Output, MU-MIMO.

According to some aspects, the sending S7 implies that the second node 10b can decode the data packet P using the at least two sub packets P′, when arriving at the second node. In other words, the second node, which is the target node for the whole data packet, receives all sub packets and from them decodes the original data packet. The second node uses information in the sub packets to put together the original data packet. The information in the sub packets is further discussed below.

According to some aspects, the method further comprises the step of determining S6 transmission properties of the respective selected transmission path. The processing circuitry 12 is configured to determine the transmission properties. According to some aspects the processing circuitry comprises a determiner 124 for determining the transmission properties. By setting the transmission properties for each transmission path the transmission of each sub packet is optimized for each specific path and packet. The transmission properties are for example the target Physical Block Error Rate, BLER. The target BLER is set per transmission path by adjusting for example coding, modulation scheme and/or transmission effect.

An example of the system where the first node obtains channel quality parameters is when possible receiving nodes transmit channel measurement reports, CQI, to the first node that the first node utilizes for determination of suitable Modulation and coding, MCS, scheme as well as corresponding Transport Block Size, TBS, for the further data transmission. Hence, the mesh network according to the disclosure uses Hybrid Automatic Repeat Request, HARQ, on the physical layer. HARQ implies that retransmissions will be requested when the quality is below a level, which may cause delays.

For optimal usage of the scarce radio spectrum it has been seen in prior art that a Block Error Rate, BLER, of 10-30% on each transmission between two nodes is a good choice. A lower BLER may imply a waste of resources, i.e. higher spectrum usage for transmission of a certain amount of data, while a higher BLER may increase the latency, reducing the link throughput and again reducing the spectrum usage, i.e. the capacity. However, for latency constrained communications BLER may be chosen lower in order to minimize the risk for retransmissions. Hence, by splitting the original packet into sub packets, the transmission properties for each sub packets may be optimized such that the target BLER is 10-30% for each sub packet.

According to some aspects, the step of sending S7 further comprises sending S7a the at least two sub packets P′ to a respective node using different physical resources in time and/or frequency domain and/or in the spatial domain. The processing circuitry 12 is configured to send, using the communication interface 11, the at least two sub packets P′. According to some aspects the communication interface uses the radio transmitter circuit 11a for sending the at least two sub packets.

In order to be able to transmit the sub packets approximately simultaneously, the different transmissions, i.e. the transmissions of the different sub packets needs to be separated, such that the signals do not interfere (too much). The separation may be done in time, frequency or in the spatial domain. Using different physical resources in the time domain implies for example Time Division Multiplexing, TDM. Separation in time here refers to multiplexing the data over a frequency channel in time, by splitting a channel into different time slots to enable different transmitters to transmit on the same frequency. By transmitting the data belonging to different transmission paths on different time-slots, the packet may be simultaneously transmitted to different receiving nodes. This may improve efficiency e.g. if the number of time slots that may be allocated to one transmitter is limited. For example, the first node chooses to transmit sub packets, originating from the same data packet, to different intermediate nodes in different time slots. Then the intermediate nodes may forward the data packet to the second node in a synchronised manner. Using different physical resources in the frequency domain implies for example Frequency Division Multiplexing, FDM. TDM and/or FDM are e.g. used if different parts of a network have different channel quality. For example, if a first set of Resource Blocks, RB, here called X, have good signal quality versus one intermediate node, while other RBs, here called Y, have better quality versus another intermediate node. Then data is scheduled on X to the first intermediate node and on Y to the other intermediate node. The intermediate nodes may be exposed to this situation to different degrees. Hence, different resources may be useful to one node while not useful or less useful to another.

Similarly as in the TDM case, when using FDM a first node may transmit sub packets, originating from the same data packet, to different intermediate nodes on different frequencies. The intermediate nodes may then forward the sub packets in a synchronised manner, and possibly even on the same frequency, depending on how sub packets are designed.

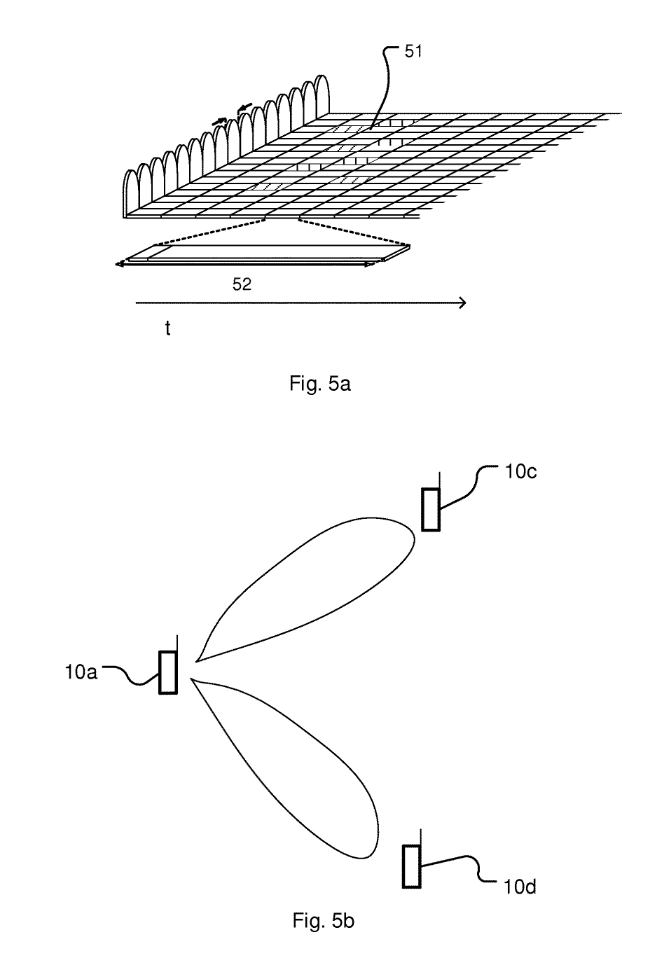

LTE uses Orthogonal Frequency Division Multiplexing, OFDM, in the downlink and Discrete Fourier Transform, DFT, -spread OFDM (a.k.a. single carrier FDMA, SC-FDMA) in the uplink. The basic LTE downlink physical resource can thus be seen as a time-frequency grid as illustrated in FIG. 5a, where each resource element 51 corresponds to one OFDM subcarrier 52 during one OFDM symbol interval. Furthermore, the resource allocation in LTE is typically described in terms of resource blocks, RB, where a resource block corresponds to one slot (0.5 ms) in the time domain and 12 contiguous subcarriers in the frequency domain. Resource blocks are numbered in the frequency domain, starting with 0 from one end of the system bandwidth.

For separation in the spatial domain the node utilizes for example precoding matrixes for beamforming and/or MIMO. This alternative is useful used when the substantially the same coding and modulation may be used for transmission on the different paths.

FIG. 5b illustrates a MIMO transmission performed by a wireless device 10a. In this case the wireless device comprises a Multiple-input and Multiple-output, MIMO, antenna configuration. Data packets are transmitted in parallel on the same frequency channel by using different precoding matrixes or antennas. In conventional MIMO both the transmitter and the receiver has multiple antennas and a signal is split in the transmitter and sent over several antennas and received in the receiver with several antennas. In the case illustrated in FIG. 5b, spatial separation is used in the transmitter 10a for transmitting the packet to two different receiving nodes 10c, 10d. However, if the receiving wireless devices then transmit the signal to a fourth device in a synchronized manner, the fourth receiving device may treat the signal as a MIMO transmission. In other words, a MIMO transmission is performed from the transmitter and the receiver's point of view but there are intermediate devices which pass on the signal. The intermediate node also does some multiplication with a precoding matrix of its own. This is because the beamforming and/or MIMO channels between the first node and the intermediate node is different from the beamforming and/or MIMO channels between the intermediate node and the second node.

According to some aspects the step of selecting S4 further comprises selecting S4a the sub packet P′ to be sent on each respective selected transmission path. The processing circuitry 12 is configured to select the sub packet P′. According to some aspects the processing circuitry uses the selector 125 for selecting the sub packets. The sub packets are for example selected such that the BLER for each transmission is within a target interval. The target interval depends on the requirements of the transmission, for example if it is important that the packet will arrive fast or if the quality of the transmission is more important. A data packet is for example divided into two sub packets where one sub packet is larger than the other and the larger sub packet is then sent over a transmission path which has better channel quality than the transmission path over which the smaller sub packet is sent.

According to some aspects the sub packets P′ are, at least partly, different parts of the data packet P or the sub packets P′ are copies of the data packet P. Accordingly, the sub packets may be copies of the first data packet for redundancy in the transmission or for even more efficiency in the transmission the sub packets are at least partly comprising different parts of the data packet. When it is very important that the data packet arrives at the receiving second node 10b the target BLER is set very low (i.e. no need for retransmissions), but to minimize the loss of data, the data packet may be sent in duplicates in different sub packets transmitted over different paths.

According to some aspects the method further comprises the step of determining S3 the number of links in a possible transmission path from the first node 10a to the second node 10b, wherein a link is a direct connection between two nodes, and wherein the selection S4, S4a is further based on the number of links. The processing circuitry 12 is configured to determine the number of links. According to some aspects the processing circuitry comprises a determiner 126 for determining the number of links. A link is a step or hop between two adjacent nodes. For example, a packet that travels from the first node 10a to the intermediate node 10c and then further on to the second node 10b passes two links, the one between the first node and the intermediate node and the one between the intermediate node and the second node. Since the number of links has an impact on the delay of a packet and on the bit error rate the selection is further based on the number of links. For example, a packet that will pass a high number of linked may transmitted in a way such that the additional delay added to the packet is minimized.

According to some aspects the step of determining S3 further comprises determining S3a a number of previous links that the data packet P has passed on its way to the first node 10a and/or accumulated delay from previous transmissions of the data packet and wherein the selection S4, S4a is further based on the number of previous links and/or the delay. The processing circuitry 12 is configured to determine the number of previous links. According to some aspects the processing circuitry comprises a determiner 127 for determining the number of previous links. In some cases the accumulated delay and expected bit error rate from previous transmissions is so high that it is preferred that future transmissions introduces minimum delay and bit errors in the data packet and the selection is therefore performed to handle this. In other words, if a packet has passed many previous links it is expected that the accumulated delay and/or bit error rate is high and future transmissions will therefore minimize further delay and errors e.g. by allocating more transmission resources (e.g. using diversity) and select a more robust transmission scheme.

Hence, the proposed technique takes into account the expected packet delay in respective further links, the total accumulated packet delay in earlier links for respective possible route and based on that information determine the best suitable route and Modulation and Coding Scheme, MCS, and Block Error Rate, BLER, target to use.

According to some aspects the selection S4 is further based on transmission requirements associated with the data packet P. Transmission requirements may be specified by the service or application to which the data packet belongs. When the transmission requirement is for example a short delay such as in a telephone call, the data packet is for example split in several smaller sub packets P′ and sent over several transmission paths so that all the sub packets arrive at the second node as fast as possible.

According to some aspects the method further comprises the step of instructing 51 possible receiving nodes 10b-e to report quality measurements to the first node 10a. The processing circuitry 12 is configured to instruct, using the communication interface 11, the possible receiving nodes 10b-e. According to some aspects the processing circuitry comprises an instructor 128 configured to instruct. In other words, the first node needs information about quality measurements in possible receiving nodes so that the selection of transmission paths may be based on the information. Receiving nodes are typically an adjacent second node 10b or intermediate nodes 10c-e. Thus, the first node receives quality measurements of all possible transmission paths for sending sub packets from the first node to the second node via intermediate nodes or directly and bases the selection of a transmission path on the received information.

According to some aspects the step of instructing S1 further comprises instructing S1a possible receiving nodes 10b-e to report other data to the first node. The processing circuitry 12 is configured to instruct, using the communication interface 11, the possible receiving nodes 10b-e. Such other data is for example number of links or delay added in previous routing. Such other data is for example quality measurements from future possible receiving nodes located between the possible receiving node and the second node. The information is used when selecting the transmission path.

According to some aspects, the disclosure further comprises that each sub packet P′ comprises information associated with the other sub packets. The information is for example associated with the transmission path from the first node 10a to the second node 10b of each other sub packet P′. The information comprises, for example, the identity of the second node 10b and/or information, which define the content of each sub packet P′. The information is needed in the intermediate node and in the second node. The second node uses the information to recreate the original data packet from the sub packets. The information is, for example, information defining how the original packet is divided into sub packets e.g. if the sub packets are equal copies of the data packet or if they comprise different parts of the data packet. According to some aspects the sub packets comprise parts of the data packet wherein at least part of the sub packets are the same. The information for example defines the relation between the content of the sub packets, for example whether it is fragmented or repetitive. In other words, the sub packets comprise information regarding the other sub packets of the same data packet and also information regarding the transmission paths and about other associated intermediate nodes in the transmission paths, of the other sub packets.

According to some aspects, the information in each sub packet comprises instructions for the receiving node, being an intermediate node 10c, 10d, whether to feed forward the sub packet P′ without decoding or to decode and re-encode it. The information may additionally or alternatively comprise synchronization information associated with future transmissions of the at least two sub packets P′. The sub packet may be decoded and re-encoded before forwarding depending on e.g. the channel quality and/or delay.

In general the decode-re-encode step removes errors. If SNR is high, then this step only removes some small errors. These accumulated, over several intermediate nodes, small errors can then instead be removed in later nodes by a decode-re-encode step, e.g. when the accumulated SNR is below a certain threshold. By skipping the decode-re-encode step the node will save power, by performing less computations, and reduce latency in the node, as the decode-re-encode step takes some time to process.

The synchronization information is used to synchronize the receiving of the sub packets in the second node. If the transmissions are synchronized so that the second node receives the packets approximately on the same time, the transmission may be handled as a MIMO transmission by the second node. The synchronization information is for example that the exact time for sending at the intermediate nodes is specified.

According to some aspects of the disclosure, the information in each sub packet defines Modulation and Coding Scheme, MCS or Resource Blocks, RB used for transmission of the other sub packets and/or accumulated latency and/or diversity index. The information is used for example when decoding the sub packets and for determining when to send the sub packets in future transmission for synchronizing the transmission with the other sub packets.

According to some aspects of the disclosure the information in each sub packet is comprised in headers of the at least two sub packets P′. The information in the sub packets enables the second node to decode the original data packet from the sub packets. It also enables for the nodes which sends the sub packets to the second node to synchronize their transmissions.

According to some aspects the communication interface 11 comprises one radio transmitter circuit 11a configured to at least partly simultaneously transmit the at least two sub packets P′. The sub packets are for example sent using different resource blocks; see FIG. 5a, or using beamforming as shown in FIG. 5b.

The wireless network is for example a Mobile Adhoc Network, MANET, a mesh network, a Personal Area Network, PAN, or a Device to Device network, D2D and the first node 10a is for example a wireless device, an access point or a base station using for example CSMA, LTE or 5G.

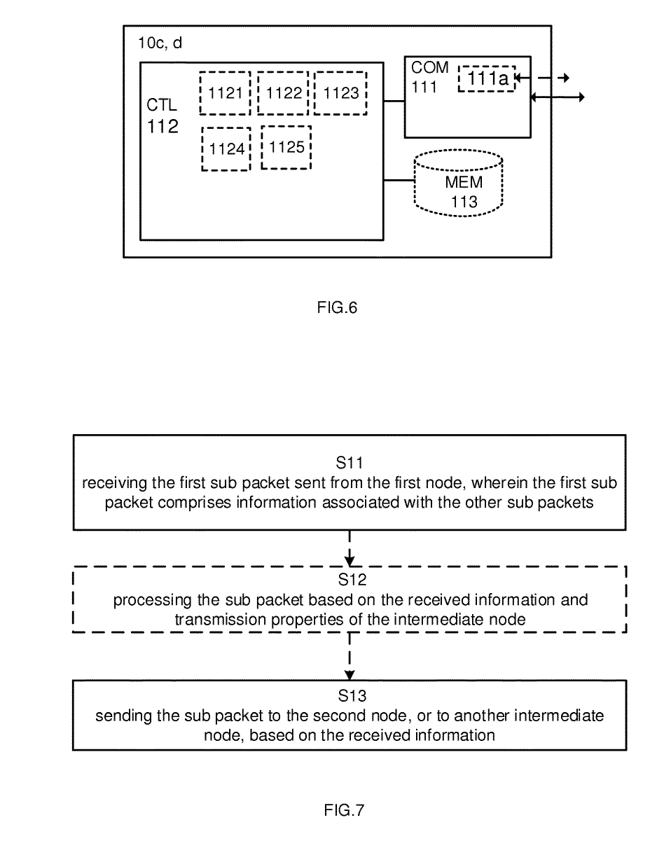

FIG. 7 is a flow diagram depicting example operations which may be taken by the intermediate node of FIG. 6, when transmitting a packet from the first node 10a to a second node 10b via at least one intermediate node.

FIG. 6 illustrates an example of an intermediate node 10c, d which may incorporate some of the example embodiments discussed above. The intermediate node is a wireless node 10c, 10d in a wireless network comprising a number of nodes 10a-e wirelessly connected to each other. The intermediate node is configured for forwarding a sub packet P′ from the first node 10a, towards a second node 10b. At least a first and a second sub packet, each sub packet comprising at least a part of a data packet P, is transmitted over different transmission paths between the first node and the second node and wherein the intermediate node is located in one of the transmission paths. The communication system is for example a wireless meshed network, implying that a packet can be sent from the first node to the second node 10b via intermediate nodes. As shown in FIG. 6, according to aspects, the intermediate node comprises a communication interface or radio circuitry 111 configured to receive and transmit any form of communications or control signals within a network. In other words, the intermediate node comprises a communication interface 111 configured for wireless communication with other nodes 10a-e in the wireless network. It should be appreciated that the radio circuitry 111 according to some aspects comprises any number of transceiving, receiving, and/or transmitting units or circuitry. It should further be appreciated that the radio circuitry may be in the form of any input/output communications port known in the art. The radio circuitry according to some aspects comprises RF circuitry and baseband processing circuitry (not shown).

The intermediate node 10c, d according to some aspects further comprises at least one memory unit or circuitry 113 that may be in communication with the radio circuitry 111. The memory may be configured to store received or transmitted data and/or executable program instructions. The memory may be any suitable type of computer readable memory and may be of volatile and/or non-volatile type.

The intermediate node 10c, d according to some aspects further comprises processing circuitry 112, which is any suitable type of computation unit, e.g. a microprocessor, Digital Signal Processor, DSP, Field Programmable Gate Array, FPGA, or Application Specific Integrated Circuit, ASIC, or any other form of circuitry. It should be appreciated that the processing circuitry need not be provided as a single unit but may be provided as any number of units or circuitry. According to some aspects the processing circuitry 112 is configured to receive S11, using the communication interface 111, the first sub packet transmitted from the first node, wherein the first sub packet comprises information associated with the other sub packets, and to send S13, using the communication interface 111, the sub packet to the second node, or to another intermediate node, based on the received information.

In other words, the method performed in the intermediate node comprises the steps of receiving S11 the first sub packet sent from the first node, wherein the first sub packet comprises information associated with the other sub packets, and sending S13 the sub packet to the second node, or to another intermediate node, based on the received information. The communication interface 111 is configured to receive the sub packet and to send the sub packet. According to some aspects the communication interface comprises a radio transceiver circuit 111a for receiving and sending sub packets.

According to some aspects the method further comprises processing S12 the sub packet P′ based on the received information and transmission properties of the intermediate node. The processing circuitry 112 is configured to process the sub packet. According to some aspects the processing circuitry comprises a processor 1121 configured to process the sub packet. The processing of a sub packet comprises for example delaying the sub packet, decoding and re-encoding the sub packet, deciding whether the synchronization requirements can be fulfilled and/or sending the sub packet according to synchronization data or synchronization information.

According to some aspects, the processing comprises decoding the sub packet P′ if the link quality is below a value. The processing circuitry 112 is configured to decoding the sub packet. According to some aspects the processing circuitry comprises a decoder 1122 configured to decode the sub packet. The quality is for example measured by using checksums (e.g. on header bits in the packet) or Signal to Noise Ratio, SNR, or Signal to Interference Ratio, SIR, measurements on pilot symbols in the packet.

The intermediate node needs to decode the header and if the decoder checksum of the header is correct or soft values seems “good enough”, the packet can be forwarded without decoding (repeater functionality). Another measure is based on SIR/SNR or pilot symbols in the header. The value is for example a percentage for allowable bit error rate for the sub packet. If the processing circuitry determines that the quality is below a value the sub packet is decoded and processed and re-encoded to minimize the error rate. If the synchronization information and quality of the sub packets are deemed to be allowable, the sub packets are fed forward without decoding. According to some aspects information regarding the actions performed on the sub packet in the intermediate node is added to the sub packet. According to some aspects the sub packet may be forwarded without decoding if the intermediate node comprises timing info of the other intermediate nodes and if the channel quality is above a threshold.

For example the intermediate node may act as follows. If a level of time synchronisation and SIR are above a threshold, then the intermediate node may feed forward the packet according to received information in the packet. If the level of time synchronisation and SIR are below a threshold, then the packet is decoded and if decoding is successful, re-encoding is performed and the packet is forwarded using e.g. Carrier Sense Multiple Access/Carrier Sense, CSMA/CS. If the decoding is unsuccessful, a NACK message is sent to the previous node (the first node or another intermediate node) and the intermediate node then waits for a retransmission.

According to some aspects the information comprises a latency flag (timing synchronization information) and/or Best suitable Resource Blocks, RB. These parameters are used to be able to select transmission mode for relaying, for example MCS, diversity or MIMO.

According to some aspects of the disclosure the information comprises synchronization requirements associated with future transmissions of the first sub packet P′, and wherein the sending S13 is based on the synchronization information. Synchronization has been discussed above when discussing the information comprised in the sub packet.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved. Also, the functions or steps noted in the blocks can according to some aspects of the disclosure be executed continuously in a loop.

It should be noted that although terminology from 3GPP LTE has been used herein to explain the example embodiments, this should not be seen as limiting the scope of the example embodiments to only the aforementioned system. Other wireless systems, including WCDMA, WiMax, Ultra Mobile Broadband, UMB and GSM, may also benefit from the example embodiments disclosed herein.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

The various example embodiments described herein are described in the general context of method steps or processes, which may be implemented according to some aspects by a computer program, comprising computer readable code which, when run on an node in a contention based communication system, causes the node to perform the method according to above. The computer program, embodied in a computer-readable medium, includes computer-executable instructions, such as program code, executed by computers in networked environments. A computer-readable medium may include removable and non-removable storage devices including, but not limited to, Read Only Memory, ROM, Random Access Memory, RAM, compact discs, CDs, digital versatile discs, DVD, etc. Generally, program modules may include routines, programs, objects, components, data structures, etc. that performs particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the following claims.

1-43. (canceled)

44. A method of sending a data packet from a first node to a second node in a wireless network; the wireless network comprising a plurality of nodes wirelessly connected to each other; wherein there are at least two possible transmission paths between the first node and the second node, with at least one of the at least two possible transmission paths comprising an intermediate node; the method comprising the first node:
creating at least two sub packets, each sub packet comprising at least a part of the data packet; and
sending the sub packets to a respective receiving node, each receiving node being part of a respective transmission path between the first node and the second node.

45. The method claim 44 further comprising the first node obtaining at least one channel quality parameter, wherein each channel quality parameter is associated with one of the at least two possible transmission paths from the first node to the second node.

46. The method of claim 45, further comprising the first node selecting at least two transmission paths of the at least two possible transmission paths based on channel quality parameters.

47. The method of claim 44 wherein the sending implies that the second node can decode the data packet using the at least two sub packets, when arriving at the second node.

48. The method of claim 46, further comprising the first node determining transmission properties of the respective selected transmission path(s).

49. The method of claim 44 wherein the sending comprises sending the at least two sub packets to a respective node using different physical resources in a time domain and/or a frequency domain.

50. The method of claim 44 wherein the sending comprises sending the at least two sub packets to a respective node using different physical resources in a spatial domain.

51. The method of claim 46, wherein the selecting comprises selecting the sub packet to be sent on each respective selected transmission path.

52. The method of claim 44 wherein the sub packets are at least partly different parts of the data packet.

53. The method of claim 44 wherein the sub packets are copies of the data packet.

54. The method claim 46, further comprising:
the first node determining the number of links in a possible transmission path from the first node to the second node, wherein a link is a direct connection between two nodes; and
wherein the selecting is further based on the number of links.

55. The method of claim 54:
wherein the determining comprises determining a number of previous links that the data packet has passed on its way to the first node and/or accumulated delay from previous transmissions of the data packet;
wherein the selecting is further based on the number of previous links and/or the delay.

56. The method of claim 46, wherein the selecting is based on transmission requirements associated with the data packet.

57. The method of claim 44 further comprising the first node instructing possible receiving nodes to report quality measurements to the first node.

58. The method of claim 57, wherein the instructing comprises instructing possible receiving nodes to report other data to the first node.

59. The method of claim 44 wherein each sub packet comprises information associated with the other sub packets.

60. The method of claim 59, wherein the information is associated with the transmission path from the first node to the second node of each other sub packet.

61. The method of claim 59, wherein the information comprises the identity of the second node.

62. The method of claim 59, wherein the information comprises information which defines the content of each sub packet.

63. The method of claim 59, wherein the information comprises instructions for the receiving node, being an intermediate node, whether to feed forward the sub packet without decoding or to decode and re-encode it.

64. The method of claim 59, wherein the information comprises synchronization information associated with future transmissions of the at least two sub packets.

65. The method of claim 59, wherein the information defines one or more of the following:
Modulation and Coding Scheme (MCS) or Resource Blocks (RB) used for transmission of the other sub packets;
accumulated latency;
diversity index.

66. The method of claim 59, wherein the information is comprised in headers of the at least two sub packets.

67. A first node in a wireless network, the network comprising a plurality of nodes wirelessly connected to each other; wherein the first node is configured to send a data packet from the first node to a second node; wherein there are at least two possible transmission paths between the first node and the second node, with at least one of the at least two possible transmission paths comprising an intermediate node; the first node comprising:
a communication interface configured for wireless communication with other nodes in the wireless network; and
processing circuitry
memory containing instructions executable by the processing circuitry whereby the first node is configured to:
create at least two sub packets, each sub packet comprising at least a part of the data packet; and
send, using the communication interface, the sub packets to a respective receiving node, the respective receiving node being part of a respective transmission path between the first node and the second node.

68. The first node of claim 67, wherein the instructions are such that the processing circuitry is configured to obtain, using the communication interface, at least one channel quality parameter; wherein each channel quality parameter is associated with one of the at least two possible transmission paths from the first node to the second node.

69. The first node of claim 67, wherein the instructions are such that the processing circuitry is configured to select at least two transmission paths of the at least two possible transmission paths for sending the data packet from the first node to the second node based on channel quality parameters.

70. The first node of claim 69, wherein the instructions are such that the processing circuitry is configured to determine transmission properties of the respective selected transmission path.

71. The first node of claim 67, wherein the instructions are such that the processing circuitry is configured to send, using the communication interface, the at least two sub packets to a respective node using different physical resources in the time domain and/or frequency domain.

72. The first node of claim 67, wherein the instructions are such that the processing circuitry is configured to send, using the communication interface, the at least two sub packets to a respective node using different physical resources in the spatial domain.

73. The first node of claim 69, wherein the instructions are such that the processing circuitry is configured to select the sub packet to be sent on each respective selected transmission path.

74. The first node of claim 69:
wherein the instructions are such that the processing circuitry is configured to determine the number of links in a possible transmission path from the first node to the second node; wherein a link is a direct connection between two nodes;
wherein the selecting is further based on the number of links.

75. The first node of claim 73:
wherein the instructions are such that the processing circuitry is configured to determine a number of previous links that the data packet has passed on its way to the first node and/or accumulated delay from previous transmissions of the data packet;
wherein the selecting is further based on the number of previous links and/or the delay.

76. The first node of claim 67, wherein the instructions are such that the processing circuitry is configured to instruct, using the communication interface, possible receiving nodes to report quality measurements to the first node.

77. The first node of claim 67, wherein the communication interface comprises one radio transmitter circuit configured to at least partly simultaneously transmit the at least two sub packets.

78. The first node of claim 67, wherein the wireless network is one of:
a Mobile Adhoc Network (MANET);
a mesh network;
a Personal Area Network (PAN);
a Device to Device (D2D) network.

79. The first node of claim 67, wherein the first node is a wireless device, an access point, or a base station.

80. A method of forwarding a sub packet from a first node towards a second node in a wireless network; the wireless network comprising a plurality of nodes wirelessly connected to each other; wherein at least a first and a second sub packet are transmitted over different transmission paths between the first node and the second node, with each sub packet comprising at least a part of a data packet; wherein an intermediate node is located in one of the transmission paths; the method comprising the intermediate node:
receiving the first sub packet sent from the first node, wherein the first sub packet comprises information associated with the other sub packets; and
sending the sub packet to the second node, or to another intermediate node, based on the received information.

81. The method of claim 80, wherein the method further comprises the intermediate node processing the sub packet based on the received information and transmission properties of the intermediate node.

82. The method of claim 81, wherein the processing comprises decoding the sub packet if the quality is below a value.

83. The method of claim 80, wherein the information comprises a latency flag and/or Best suitable Resource Blocks.

84. The method of claim 80:
wherein the information comprises synchronization requirements associated with future transmissions of the first sub packet; and
wherein the sending is based on the synchronization information.

85. An intermediate node in a wireless network; the wireless network comprising a plurality of nodes wirelessly connected to each other; wherein the intermediate node is configured to forward a sub packet from a first node towards a second node; wherein at least a first and a second sub packet are transmitted over different transmission paths between the first node and the second node; wherein the intermediate node is located in one of the transmission paths; wherein the first sub packet and the second sub packet each comprise at least a part of a data packet; the intermediate node comprising:
a communication interface configured for wireless communication with other nodes in the wireless network;
processing circuitry;
memory containing instructions executable by the processing circuitry whereby the intermediate node is configured to:
receive, using the communication interface, the first sub packet transmitted from the first node; wherein the first sub packet comprises information associated with the other sub packets; and
send, using the communication interface, the sub packet to the second node, or to another intermediate node, based on the received information.

86. A non-transitory computer readable recording medium storing a computer program product for sending a data packet from a first node to a second node in a wireless network; the wireless network comprising a plurality of nodes wirelessly connected to each other; wherein there are at least two possible transmission paths between the first node and the second node, with at least one of the at least two possible transmission paths comprising an intermediate node; the computer program product comprising software instructions which, when run on processing circuitry of the first node entity, causes the first node to:
create at least two sub packets, each sub packet comprising at least a part of the data packet; and
send the sub packets to a respective receiving node, each receiving node being part of a respective transmission path between the first node and the second node.

87. A non-transitory computer readable recording medium storing a computer program product for forwarding a sub packet from a first node towards a second node in a wireless network; the wireless network comprising a plurality of nodes wirelessly connected to each other; wherein at least a first and a second sub packet are transmitted over different transmission paths between the first node and the second node, with each sub packet comprising at least a part of a data packet; wherein an intermediate node is located in one of the transmission paths; the computer program product comprising software instructions which, when run on processing circuitry of the intermediate node, causes the intermediate node to:
receive the first sub packet sent from the first node, wherein the first sub packet comprises information associated with the other sub packets; and
send the sub packet to the second node, or to another intermediate node, based on the received information.
